(19) United States
(12) Patent Application Publication
(10) Pub. No.: US 2022/0048622 A1
(43) Pub. Date: Feb. 17, 2022

(54) UNMANNED AERIAL VEHICLE AND MOVING BODY

(71) Applicant: NILEWORKS INC., Tokyo (JP)

(72) Inventors: Chihiro WAKE, Tokyo (JP); Hiroshi YANAGISHITA, Tokyo (JP)

(21) Appl. No.: 17/276,581

(22) PCT Filed: Feb. 28, 2019
(86) PCT No.: PCT/JP2019/007744

§ 371 Date: Mar. 16, 2021

(30) Foreign Application Priority Data
Mar. 7, 2018 (JP) 2018-041029
Oct. 16, 2018 (JP) 2018-194838

(51) Int. Cl. B64C 39/02; H01M 10/48; H02J 7/00; H02H 7/18

(52) U.S. Cl. CPC B64C 39/024; H01M 10/486; H02J 7/0031; H01M 2220/20; B64C 2201/042; H02J 7/00306; H02J 7/00302; H02H 7/18

(57) ABSTRACT

An unmanned aerial vehicle that can be disabled when it detects a phenomenon causing a malfunction of a battery is provided. The unmanned aerial vehicle is capable of carrying a detachable battery and has a battery pack, sensors detecting a phenomenon causing a malfunction of the battery pack, a memory storing the detection signal of the sensors, and cutoff circuits cutting off a power supply line from the battery pack by the detection signal. The sensor is an aerial vehicle side sensor equipped outside of the battery and on an unmanned aerial vehicle side. The memory is equipped in the battery and stores the detection signal of the aerial vehicle side sensor received through a connector connecting the battery and the unmanned aerial vehicle. The cutoff circuit is equipped on the unmanned aerial vehicle side and cuts off the power supply line from the battery pack.

### TECHNICAL FIELD

The present invention relates to an unmanned aerial vehicle and a moving body.

### BACKGROUND ART

The use of unmanned aerial vehicles (hereinafter also referred to as “drones”) is in progress. One of the important fields of use of drones is the spraying of chemicals such as pesticides and liquid fertilizers on farmland, that is, farm fields (for example, see Patent Literature 1). In Japan where farmland is smaller than in the Europe and the U.S., the chemical spraying by drones are more suitable than the chemical spraying by manned airplanes and helicopters in many cases.

By using technologies such as a Quasi-Zenith Satellite System (QZSS) and an RTK-GPS, a drone can accurately know the absolute position of the own plane in centimeters during flight. Thus, even in the typical small and complex farmland in Japan, autonomous flight reduces manual maneuvering and enables efficient and accurate chemical spraying.

On the other hand, it is necessary to consider safety, for example, for autonomous drones used for spraying agricultural chemicals or the like. Since a drone loaded with chemicals weighs several tens of kilograms, the case of an accident such as falling onto a person may have serious consequences. Further, the operator of a drone is not an expert on drones, so therefore a foolproof mechanism is required to ensure safety even for nonexperts. Until now, there have been drone safety technologies based on human control (for example, see Patent Literature 2), but there was no technology for addressing safety issues specific to autonomous drones for spraying agricultural chemicals.

Drones are generally driven by an electric motor, and a battery is installed as a power source to drive the electric motor. Therefore, in the drone in which safety is strictly required as described above, it is required to prevent the battery from malfunctioning and prevent the malfunction of the battery from becoming a factor of the malfunction of the drone.

### CITATION LIST

### Patent Literature

Patent Literature 1: JP 2001-120151 A

Patent Literature 2: JP 2017-163265 A

### SUMMARY OF INVENTION

### Technical Problem

An object of the present invention is to provide an unmanned aerial vehicle to prevent an occurrence of a malfunction caused by a malfunction of a battery.

### Solution to Problem

An unmanned aerial vehicle according to the present invention is capable of carrying a battery and has a sensor on an unmanned aerial vehicle side detecting a phenomenon causing a failure in a function of the battery and a cutoff circuit cutting off an output from the battery. The cutoff circuit cuts off the output from the battery by a detection signal of the sensor.

Further, a moving body according to another aspect of the present invention is capable of carrying a battery and has a sensor detecting a phenomenon causing a failure in a function of the battery and a cutoff circuit cutting off an output from the battery. The cutoff circuit cuts off the output from the battery by a detection signal of the sensor.

### ADVANTAGEOUS EFFECTS OF INVENTION

According to the unmanned aerial vehicle of the present invention, since a power supply line from the battery is cut off by the detection signal of the aerial vehicle side sensor, it is possible to prevent the malfunction of the battery from impairing the function of the unmanned aerial vehicle.

### BRIEF DESCRIPTION OF DRAWINGS

FIG. 1 is a block diagram illustrating an overview of an embodiment of the unmanned aerial vehicle according to the present invention.

FIG. 2 is a block diagram illustrating another embodiment of the unmanned aerial vehicle according to the present invention.

FIG. 3 is a block diagram illustrating yet another embodiment of the unmanned aerial vehicle according to the present invention.

FIG. 4 is a block diagram illustrating yet another embodiment of the unmanned aerial vehicle according to the present invention.

FIG. 5 is a block diagram illustrating yet another embodiment of the unmanned aerial vehicle according to the present invention.

FIG. 6 is a block diagram illustrating an embodiment of a battery included in the unmanned aerial vehicle and an embodiment of a charger of this battery.

FIG. 7 is a plan view illustrating an overview of a drone as the unmanned aerial vehicle.

FIG. 8 is a block diagram illustrating an embodiment of a control system of the drone.

### DESCRIPTION OF EMBODIMENTS

Hereinafter, an embodiment of an unmanned aerial vehicle according to the present invention will be described with reference to the drawings.

### Embodiment

### Overview of Unmanned Aerial Vehicle (Drone)

As illustrated in FIG. 7, a drone 2 has a plurality of rotor blades 101 (four in the illustrated embodiment) that are rotationally driven about an axis. Each of the above mentioned rotor blades 101 is rotationally driven by an individual motor 21 to generate an axial thrust by generating an axial air flow. Each of the above mentioned rotor blades 101 is attached to a tips of four arms extending from a main body 104 of the drone 2 together with the above mentioned motor 21.

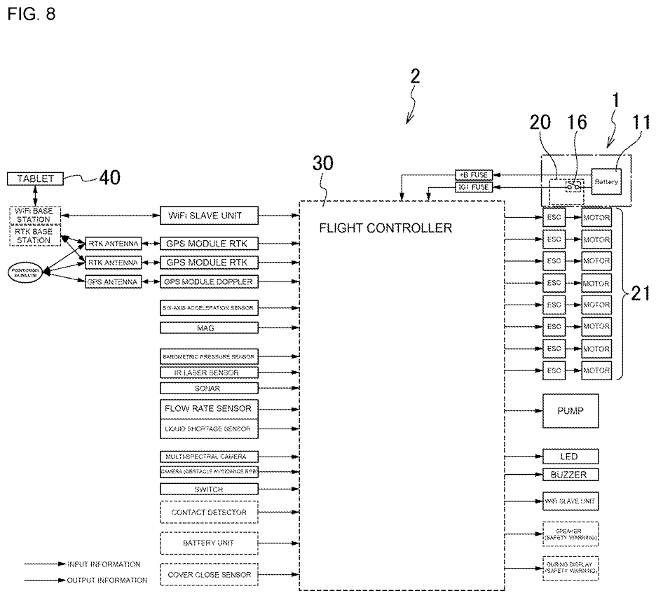

The drone 2 has a flight controller 30 (see FIG. 8) in the main body 104 that individually controls the rotation speed and rotation direction of each of the above mentioned rotor blades 101. By individually controlling the rotation of each of the rotor blades 101 via a drive unit, the flight controller 30 can perform various operations required for the drone 2, such as takeoff and landing, forward, backward, upward, downward, left and right movement, and hovering.

The flight controller illustrated in FIG. 8 constitutes the flight controller 30 described above. In FIG. 8, the flight controller 30 is shown at a center to illustrate signal input elements to the flight controller 30 and a control target where operations are controlled by an output signal of the flight controller 30. Of these signal input elements and control targets, those directly related to the present invention will be mainly described below.

In FIG. 8, a command signal transmitted from the tablet 40 and detection signals from various sensors and the like, are input to the flight controller 30. Based on above mentioned various input signals, the flight controller 30 controls a power supply to each of the motor 21 that rotationally drives each of the rotor blades 101, and controls the rotation speed of each of the rotor blades 101. The drone 2 is an autonomous drone that operates according to a program set by the tablet 40 while checking a position by GPS data and checking the signals from various sensors.

Although four rotor blades 101 are illustrated in FIG. 7, other rotor blades are arranged on extension lines of rotation axes of each of the rotor blades 101, and a total of eight rotor blades are arranged. In FIG. 8, eight the motors 21 that individually rotate and drive eight rotor blades are described. Two rotor blades arranged on a same axis are rotationally driven in opposite directions to each other, and torsional directions of the rotor blades are opposite to each other so that thrusts are generated in a same direction.

However, in the present invention, a number of the rotor blades 101 is arbitrary, and it is arbitrary whether a number of rotor blades on one axis is going to be singular or plural.

As shown in FIG. 8, the drone 2 can include a battery 1 that drives each of the motors 21. The battery 1 has a battery pack 11, and a power is supplied to each of the motor 21 from the battery pack 11 via the drive unit controlled by the flight controller 30.

The battery 1 includes a switch 16 and a cutoff circuit 20 having a switch controller for controlling on/off of the switch 16. The switch 16 is an opening/closing switch connected in series to a power supply line from the battery pack 11, and is normally controlled by the switch controller to maintain an ON state. The battery pack 11 includes one or more rechargeable battery cells of, for example, a lithium ion type.

Although not shown in FIG. 8, the battery 1 has a detection unit for detecting a phenomenon that causes a failure in a function of the drone 2 or the like, which becomes a load of the battery 1, and for outputting a signal. The switch controller of the cutoff circuit 20 switches the switch 16 off when the detection signal of the detection unit is input. The detailed configuration of the battery 1 and an on/off control of the switch 16 by a power supply controller will be described below.

### Embodiment of Battery

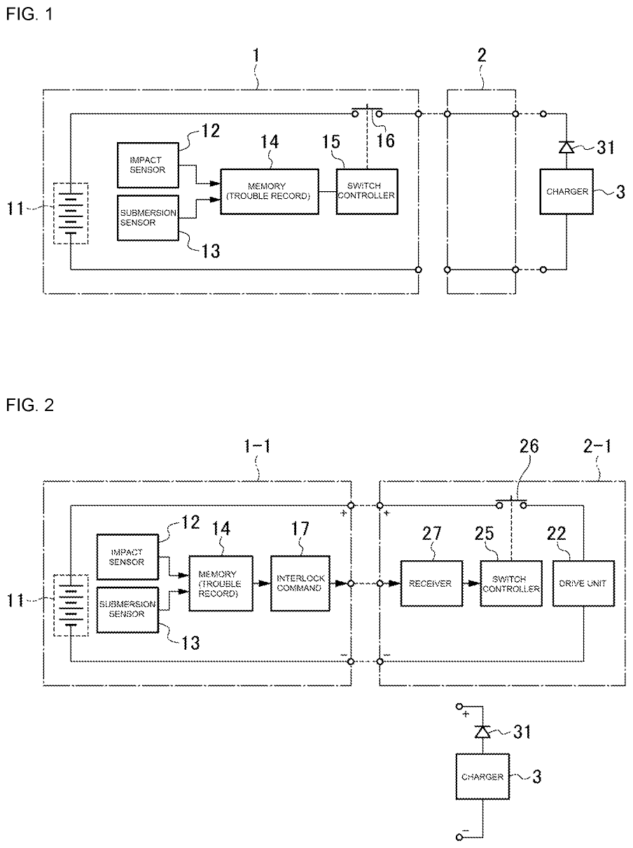

In FIG. 1, reference numeral 1 denotes a battery. The battery 1 is a rechargeable battery such as a lithium ion battery. The battery 1 has the battery pack 11 comprising one or more of the battery cells. The battery pack 11 serves as a driving power source for driving various devices, and is provided with the switch 16 for turning on and off a power supply output line from the battery pack 11.

The battery 1 shown in FIG. 1 includes, in addition to the switch 16, sensors 12 and 13 for detecting a phenomenon causing a failure in the function of the battery 1, a memory 14, and a switch controller 15 for turning on and off the switch 16.

As the sensors for detecting the phenomenon causing the failure in the function of the battery 1, an embodiment shown in FIG. 1 has an impact sensor 12 and a submersion sensor 13. When the battery 1 is a lithium-ion battery, for example, and an impact force is applied to change the structure of the battery cells, failures such as an increase in temperature and ignition may occur. Causes of such failures are detected by the impact sensor 12. In addition, when the battery 1 is submerged, the battery 1 may not perform sufficiently and an operation of the device powered by the battery 1 may be impaired. Causes of such failures are detected by the submersion sensor 13.

The sensors for detecting the phenomenon causing the failure in the function of the battery 1 are not limited to the impact sensor 12 and the submersion sensor 13. For example, a temperature sensor may be provided if a history of exposure to extremely high or low temperatures impairs the function of the battery 1.

Detection signals of the impact sensor 12 and the submersion sensor 13, that is, signals indicating a trouble, are once inputted to the memory 14, and the trouble is stored in the memory 14 as a history of the battery 1. The memory 14 inputs the detection signal to the switch controller 15. The switch controller 15 switches off the switch 16 when the detection signal is input.

The switch controller 15 and the switch 16 constitute a cutoff circuit for cutting off the output of the battery pack 11 by the detection signals of the impact sensor 12 and the submersion sensor 13. The memory 14 stores the detection signals of the impact sensor 12 and the submersion sensor 13, and inputs the detection signals to the cutoff circuit. The detection signals of the sensors 12 and 13 may be input to the memory 14 and directly to the switch controller 15.

Normally, the switch 16 is turned on so that the power can be supplied from a power output line to an external device, and the operating power is supplied to the memory 14 and the switch controller 15 in the battery 1. The switch controller 15 may be configured to turn on to self-hold the switch 16 in a normal state and release the self-holding of the switch 16 by the detection signals of the impact sensor 12 or the submersion sensor 13.

The battery 1 can be mounted on various devices and used as a power source for various devices. In an embodiment shown in FIG. 1, the drone 2 which is an unmanned aerial vehicle is connected to the power output line to supply the driving power source to the drone 2.

A charger 3 can also be connected to the above mentioned power output line. In the embodiment of the charger 3 shown in FIG. 1, an AC power supply is rectified and converted into a DC power supply having a predetermined voltage to charge the battery pack 11. The internal configuration of the charger 3 is the same as the internal configuration of the charger that is already known, and in addition to a rectifier circuit, it has, for example, a smoothing circuit, a voltage control circuit and a current control circuit as needed. A diode for a reverse current protection is connected to the output line of the charger 3. The battery pack 11 can be charged by connecting the output line of the charger 3 to the power output line with the battery 1 in normal condition, in other words, the switch 16 is ON.

According to the battery 1 described above, when the function of the battery 1 is impaired, for example, when an impact force is applied or the battery is submerged, the output line from the battery pack 11 is cut off, and the battery 1 itself is disabled. If the battery 1 can be used while the battery 1, which cannot perform as the driving power source of the drone 2, is mounted on the drone 2, a serious trouble may occur in the drone 2. However, the above mentioned battery 1 disables the battery 1 itself if it has a history that may impair its function, so even if it is installed in the drone 2, the drone 2 cannot operate and the serious trouble of the drone 2 can be prevented.

The cutoff circuit for cutting off the output of the battery pack 11 with the detection signals of the impact sensor 12 and the submersion sensor 13 may be provided on a side of the unmanned aerial vehicle such as the drone 2. Hereinafter, embodiments of the unmanned aerial vehicle according to the present invention will be described below.

### Embodiment 1 of an Unmanned Aerial Vehicle

In FIG. 2, similar to the battery 1 shown in FIG. 1, a battery 1-1 has the battery pack 11, the impact sensor 12, the submersion sensor 13, and the memory 14, and these are connected in the same manner as in the battery 1. The battery 1-1 differs from the battery 1 shown in FIG. 1 in that the cutoff circuit having the switch controller 25 and the switch 26 is provided on the drone 2-1 side. The data stored in the memory 14 of the battery 1-1 is input to an interlock command unit 17 in the battery 1-1. An output signal of the interlock command unit 17 is configured to be received by a receiver 27 on a drone 2-1 side and input to the switch controller 25.

The interlock command unit 17 generates an interlock command signal from the stored data when the detection signals of the impact sensor 12 and the submersion sensor 13 are stored in the memory 14. The interlock command signal is a signal for cutting off an output from the battery pack 11 and the battery 1-1 is disabled.

The output line from the battery pack 11 is connected to the drone 2-1 side via an appropriate connector, and power is supplied to the drive unit 22 of the drone 2-1. As described above, the drive unit 22 controls the power supply to each of the motor 21 to perform its function as the drone 2-1. The switch 26 configuring the above mentioned cutoff circuit is arranged on the output line from the battery pack on the drone 2-1 side. The interlock command signal generated by the interlock command unit 17 is received by the receiver 27 of the drone 2-1 via an appropriate connector and input to the switch controller 25.

As in the embodiment shown in FIG. 2, a signal transmission can be simplified by performing a signal transmission between the battery and the drone with the interlock command unit 17 and the receiver 27. Assuming that the data in the memory is transmitted, there is a drawback that a structure of the data becomes complicated.

The charger 3 can be connected to the output line from the battery pack 11 of the battery 1-1 via a connector as appropriate in place of the drone 2-1. The diode 31 for the reverse current protection is connected to the output line of the charger 3. The battery pack 11 can be charged by connecting the battery 1-1 and the charger 3.

According to the embodiment of the drone as the above mentioned unmanned aerial vehicle, when the battery 1-1 is connected to the drone 2-1, the cutoff circuit on the drone 2-1 side cuts off the output line from the battery pack 11. In other words, the detection signals from the sensor 12 and the sensor 13 are stored in the memory 14 on the battery 1-1 side, and the cutoff circuit on the drone 2-1 side cuts off the power supply from the battery pack 11 to the drone 2-1 by these detection signals. Therefore, a reuse of the battery 1-1 having a failure is prohibited, and it is possible to prevent an accident due to a crash or uncontrollability of the drone 2-1 due to the failure of the battery 1-1.

The battery 1-1 in the above embodiment does not have the cutoff circuit from the battery pack described with respect to FIG. 1, but has the interlock command unit 17 that outputs the interlock command signal toward the outside. The interlock command unit 17 constitutes a command signal output unit to cut off the output from the battery pack 11, and prohibits the reuse of a particular battery if it is not suitable for use. With such a configuration, it is not necessary to provide the cutoff circuit in the battery 1-1. In a case of an agricultural drone, since a plurality of batteries are prepared for one drone, cost reduction and space saving can be achieved by simplifying the configuration of the batteries as described above.

### Embodiment 2 of Unmanned Aerial Vehicle

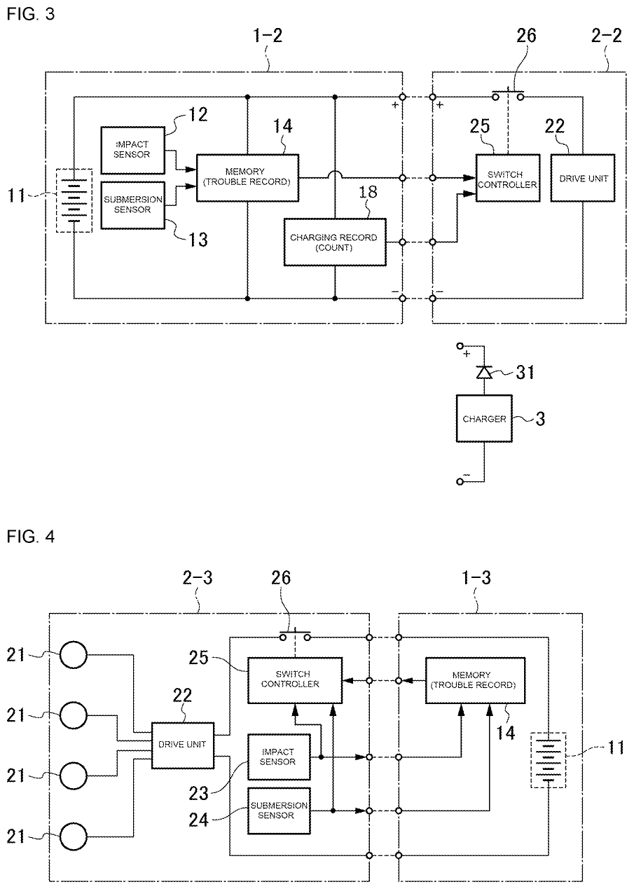

FIG. 3 shows a second embodiment of a drone which is an unmanned aerial vehicle. A feature of this embodiment is that a battery 1-2 has the charging record unit 18. When a charger is connected to the battery 1-2, a charging voltage is applied, a charging current flows, and the battery 1-2 is charged, the charging record unit 18 counts and records the number of charges. When the charging record unit 18 reaches a predetermined number of charges that affect the life of the battery 1, it activates the switch controller 25 that constitutes a cutoff circuit on a drone 2-2 side to switch off the switch 26.

The configuration on the drone 2-2 side is almost the same as the configuration on the drone 2-1 shown in FIG. 2, except that an output signal of the charging record unit 18 is input to the switch controller 25 on a drone 2-2 side through a connector or the like.

In addition, when a charging voltage is applied from an output terminal of the charger 3 to the charging record unit 18 on a battery 1-2 side, the charging record unit 18 counts a number of charges and records a count value. When the count value of the charging record unit 18 exceeds a threshold value set to determine the life of the battery 1-2, the charging record unit 18 sends a signal to the switch controller 25 on the drone 2-2 side. When the signal from the charging record unit 18 is input, the switch controller 25 turns off the switch 26 and shuts off the output line from the battery pack 11.

When the battery 1-2 reaches the end of its life, the output line of the battery pack 11 is cut off, and a used of the battery 1-2 is disabled. As a result, it is possible to prevent troubles of the drone 2-2 caused by a performance deterioration of the battery 1-2 while using an apparatus equipped with the battery 1.

Although not shown in FIG. 3, it is preferable to provide the interlock command unit 17 in the embodiment shown in FIG. 2 on the battery 1-2 side and the receiver 27 on a drone side.

### Embodiment 3 of Unmanned Aerial Vehicle

Then, a third embodiment of the above-mentioned unmanned aerial vehicle or the drone having the battery will be described with reference to FIG. 4.

The drone 2-3 shown in FIG. 4 is different from the drone 2-2 shown in FIG. 3 in that the drone 2-3 itself has the impact sensor 23 and the submersion sensor 24 as sensors for detecting a phenomenon causing a failure in the function of the battery. The impact sensor 23 and the submersion sensor 24 are sensors similar to the impact sensor 12 and the submersion sensor 13 provided on a battery side. The detection signals of the impact sensor 23 and the submersion sensor 24 on the drone 2-3 side are input to the switch controller 25. The switch controller 25 controls on/off of the output line from the battery pack 11 of the battery 1-3.

The detection signals of the impact sensor 23 and the submersion sensor 24 on the aerial vehicle side are transmitted to the memory 14 of the battery 1-3. When a phenomenon that impairs the function of the battery pack 11, for example, an impact force is applied or the battery is submerged, the detection signals are output from the sensor 23 or the sensor 24, and the memory 14 stores these detection signals. In other words, the memory 14 stores the trouble, and the stored the detection signals of the sensor 23 or the sensor 24 are input to the switch controller 25 on the drone 2-3 side. When the detection signals are input, the switch controller 25 turns off the switch 26 on the output line from the battery pack 11 of the battery 1-3 and cuts off the power supply line.

As is well known, the drone 2-3 has a plurality of propellers and a plurality of the motors 21 which rotary drive each of the propellers individually. Each of the motor 21 is supplied with power from the battery 1-3 through a motor drive unit 22. The number of the motor 21 in this embodiment is 4, but the number is not limited to this, and may be 4 or more or 4 or less. Further, when two propellers are provided on one shaft and the rotation directions of the propellers are reversed from each other, the number of motors becomes twice the number of the shafts.

The motor drive unit 22 controls the rotation of each of the motor 21 by, for example, a preset program, and performs operations required for the drone, such as upward, downward, forward, backward, and hovering.

A power supply from the battery 1-3 to the drone 2-3 and the transmission of signals on both sides are appropriately performed through the connector and the switch 26.

The drone 2-3 is usually equipped with a six-axis acceleration sensor to control a posture. An acceleration sensor and an angular velocity sensor are equipped on each of three axes, such as a roll axis, a pitch axis and a yaw axis, and these are collectively called a six-axis acceleration sensor. These acceleration sensor and angular velocity sensor output abnormal signals in response to an abnormal impact force applied to the drone 2-3 which is not possible during a normal flight. By outputting these abnormal signals as detection signals, the six-axis acceleration sensor can be used as the impact sensor 23 on the unmanned aerial vehicle side.

In addition, the drone 2-3 is equipped with propeller guards 50 to prevent propellers from coming into contact with obstacles and to prevent the propellers from coming into contact with a human body and damaging the human body. By providing a sensor that operates by this impact force, this sensor can be used as the impact sensor 23 on the unmanned aerial vehicle side when an abnormal impact force is applied to this propeller guards 50.

When the drone 2-3 is applied an abnormal impact or submerged, it may impair the function of the battery pack 11.

Therefore, in the drone 2-3 according to this embodiment, the detection signals of the impact sensor 23 or the submersion sensor 24 on the drone 2-3 side are transmitted to the battery 1-3 side, and the output line of the battery pack 11 is cut off.

Thereafter, the battery 1-3 cannot be used, and a malfunction of the drone 2 caused by a malfunction of the battery 1-3 can be prevented.

Moreover, in this embodiment, the interlock command unit 17 in the embodiment shown in FIG. 2 may be provided on the battery 1-2 side, and the receiver 27 may be provided on the drone side.

### Embodiment 4 of Unmanned Aerial Vehicle

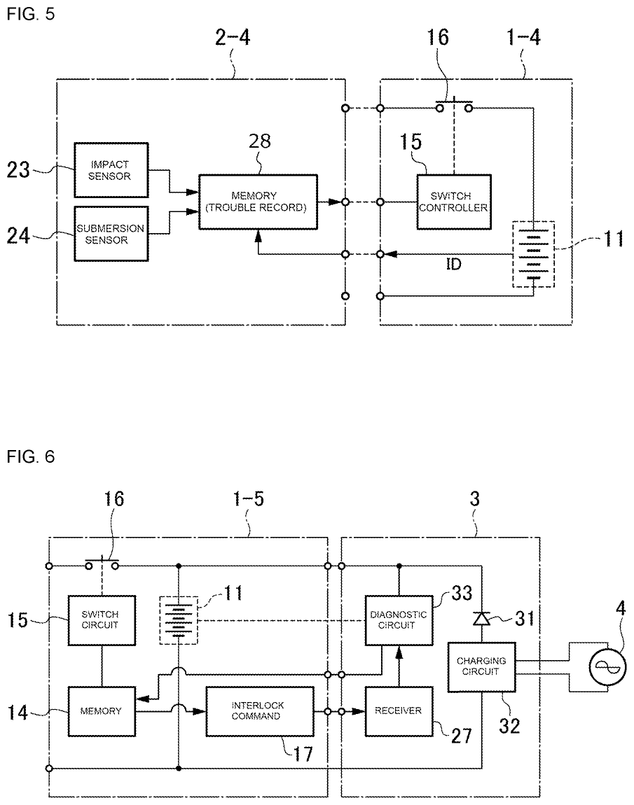

FIG. 5 illustrates a fourth embodiment of the drone as an unmanned aerial vehicle. One of the differences between this embodiment and the above mentioned embodiments is that an ID that identifies each individual is assigned to a battery 1-4, and a signal of this ID is transmitted to a drone 2-4 side. In addition, a memory 28 on the aerial vehicle side is provided on the drone 2-4 side. The signal of the ID transmitted from the battery 1-4 side to the drone 2-4 side is stored in the aerial vehicle side memory 28 on the aerial vehicle side.

The memory 28 on the aerial vehicle side also stores the detection signals by the impact sensor 23 on the aerial vehicle side and the submersion sensor 24 on the aerial vehicle side.

The memory 28 on the aerial vehicle side stores the detection signals of the sensors 23 and 24 and the ID of the battery 1-4 used at that time in association with each other, so that it is possible to store a history of whether a specific battery 1-4, identified by the ID, is the one that cuts off the output. If the battery 1-4, which is the one being used, is found that it has been cut off in the past, the memory 28 transmits a signal to the switch controller 15 of the battery 1-4. Upon receiving this signal, the switch controller 15 switches the switch 16 off and disables the battery 1-4.

As described above, in the embodiment of the drone shown in FIG. 5, a cutoff circuit of the battery 1-4 cuts off the output of the battery pack 11 when the battery 1-4, which has a history of occurrence of a phenomenon that impairs the function, is placed on the drone 2-4. Therefore, during the operation of the drone 2-4, it is possible to prevent a malfunction of the drone 2-4 caused by a failure of the battery 1-4.

In addition, in this embodiment, the interlock command unit 17 in the embodiment shown in FIG. 2 should be provided on the battery 1-2 side, and the receiver 27 should be provided on the drone side.

A cutoff circuit similar to the cutoff circuit with the switch controller 15 and the switch 16 is provided on the drone 2-4 side, and when a defective battery is equipped with the drone 2-4, the cutoff circuit of the drone 2-4 may cut off the power supply line.

The switch controller and the switch opened and closed by this switch controller and the memory may be provided only on the drone side and may not be provided on the battery side. Agricultural drones are big enough to carry as many chemicals as possible, and their battery capacity is correspondingly large and expensive. Therefore, it is desirable that a number of members attached to the battery is reduced as much as possible to reduce the size and cost. As described above, by not providing the switch controller, the switch, and the memory on the battery side, it is possible to reduce the size and cost of the battery.

### Embodiment of Charger

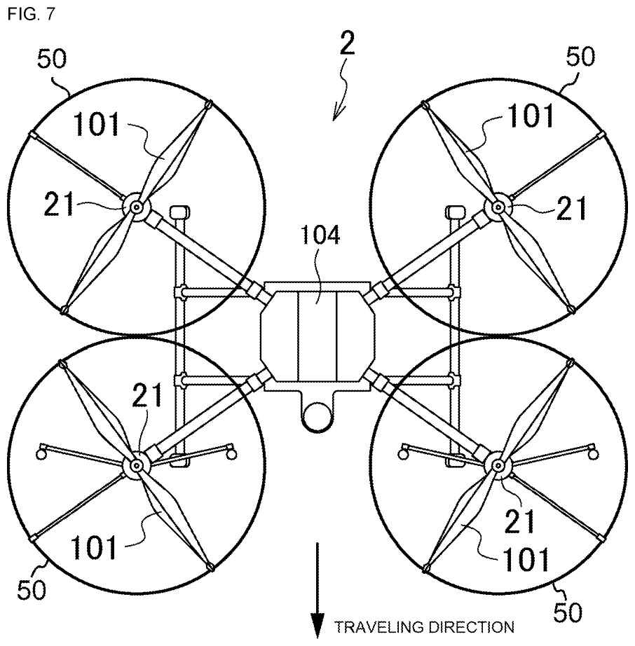

FIG. 6 shows an embodiment of the charger having a function of automatically diagnosing whether the battery is normal when charging the battery. In FIG. 6, the charger 3 has a charging circuit 32 and a diagnostic circuit 33. The charging circuit 32 rectifies and smooths, converts a commercial AC power supply 4 to an appropriate DC voltage, and supplies the charging current to the battery pack 11 of the batteries 1-5 through a reverse current protection diode 31.

The voltage of the battery pack 11 is applied to the diagnostic circuit 33, and data of the history of the battery 1-5 stored in the memory 14 of the battery 1-5 is input through the interlock command unit 17 on the battery 1-5 side and the receiver 27 on the charger 3 side. The diagnostic data of the diagnostic circuit 33 is input and stored in the above mentioned memory 14. The diagnostic circuit 33 also has a temperature sensor necessary for the diagnosis of the battery 1-5, a periodic voltage amplitude generation circuit for analysis using impedance, and the like. By loading the battery 1-5 with the charger 3, or by connecting the connector of the charger 3 to the connector of the battery 1-5 while it is equipped on the drone, the battery 1-5 is connected to the charger 3.

The following are embodiments of diagnostic methods using the diagnostic circuit 33.

1. Number of impacts, number of submersions: Based on the data of the history stored in the memory 14
2. Deterioration: Depends on the number of charges and discharges, internal resistance, and the interrelationship between battery temperature, voltage, and an amount of charge
3. Impedance analysis: Performed by applying a periodic voltage signal to the battery

The battery temperature can be measured by contacting the battery 1-5 of a thermometer built in the diagnostic circuit 33, or by measuring with infrared rays.

If the diagnostic circuit 33 determines that at least one is not normal, charging is rejected and the diagnostic data is input and stored in the memory 14 of the battery 1-5. Based on this data stored in the memory 14, the cutoff circuit consisting of the switch controller 15 and the switch 16 cuts off the output line from the battery pack 11 and disables the battery 1-5. In other words, the battery 1-5 is interlocked, and the battery 1-5 is put in a nonreusable state.

When the diagnostic circuit 33 determines that the battery 1-5 is normal, the battery 1-5 is charged, and the diagnostic data indicating that it is normal is input and stored to the memory 14 of the battery 1-5. Based on this diagnostic data from the memory 14, the cutoff circuit consisting of the switch controller 15 and the switch 16 turns on the output line from the battery pack 11 and allows the use of the battery 1-5.

Depending on diagnostic items by the diagnostic circuit 33, there are items that can be recovered by charging rather than a fundamental problem of the battery 1-5. For example, the above-mentioned internal resistance, the interrelationship between the battery temperature, the voltage, and the amount of charge, or the diagnosis by impedance analysis. When the problem of the battery 1-5 is resolved as a result of charging, the diagnostic circuit 33 sends the diagnostic data that the battery 1-5 is normal to the memory 14 of the battery 1-5.

The memory 14 clears the data to disable the battery 1-5 by inputting the above mentioned diagnostic data. When the diagnostic data in the memory 14 is cleared, the switch controller 15, which configures the cutoff circuit, turns on and restores the switch 16 and enables the batteries 1-5.

A diagnostic device having a diagnostic function similar to that of the diagnostic circuit 33 may be installed in a base or a department for providing maintenance or service of the drone, and the battery may be diagnosed before use or periodically.

When the battery has a sensor such as an impact sensor or a submersion sensor for detecting a phenomenon that causes a failure in the function of the battery, a memory for storing the detection signals of the sensors may be provided on the charger side. The memory may also store an ID, identifying each battery individually, and when the battery identified by the ID has a history of cutting off the output, charging of the battery may be prohibited.

If the battery has a history of damage such as impact or submersion, charging or discharging the battery with a load may cause problems such as overheating or ignition of the battery. By configuring the charger as described above, it is possible to substantially prohibit the reuse of the battery which may cause the failure, and to prevent the failure of the drone caused by the failure of the battery.

### Modification Embodiment

The battery, the unmanned aerial vehicle, and the charger according to the present invention may be modified as follows.

Embodiments of the unmanned aerial vehicle have been described as applications of the battery according to the present invention, but the present invention is not limited thereto. For example, it may be a moving body on land, on water, or in water. It may be a manned mobile body. Since weight of a main body of the moving body affects the energy consumption in moving, it is desirable to make the moving body as light as possible. Therefore, by making the battery detachable and configuring a charging equipment outside of the moving body, the moving body can be lighter than a configuration in which the moving body is provided with a charging mechanism. Further, in order to prevent the battery from malfunctioning, it is conceivable to protect an outer shell of the battery equipped on the moving body. However, in order to reduce the weight of the moving body, it is necessary to simplify the structure for protecting the outer shell of the battery as much as possible. According to the present invention, the use of the battery that may cause a malfunction can be reliably prohibited, so that the battery can be used safely while simplifying the protection of the outer shell of the battery. Furthermore, since the moving body itself has kinetic energy, it is highly likely that the moving body receives a very large impact as compared with a stationary object. Therefore, it is difficult to protect the battery from all possible impacts even if the outer shell of the battery is strengthened. According to the present invention, the use of the battery that may cause a malfunction can be reliably prohibited, so that the battery can be used safely.

The switches that cutoff the output of the battery may be provided on both sides of the battery and the unmanned aerial vehicle. In this case, the switch controller may be provided on both sides of the battery and the unmanned the aerial vehicle, or the switch controller provided on one side may control the switches on both sides.

Rechargeable batteries tend to have a shorter life due to overcharge or over-discharge. Therefore, overcharge or over-discharge is detected and stored in the memory, and an allowable number of times of charging is reduced for the battery having a history of overcharge or over-discharge. As a result, it is possible to reduce the probability of trouble occurring in various devices due to the battery troubles.

Some chargers have a circuit that prevents the battery from overcharging. Therefore, an overcharge prevention circuit of the charger may be used to store the history of overcharge in the memory of the battery.

The battery for the drone supplies power to the PMU (a step-down electric machine) on the drone side with a relatively high terminal voltage. The PMU reduces the terminal voltage of the battery to a voltage suitable for each part of the drone and distributes the power supply to each part. Therefore, the PMU may have a function as the cutoff circuit for cutting off the distribution of the power supply to each part. In other words, if it is detected that the battery installed in the drone is inappropriate, the function of the PMU as the cutoff circuit cuts off the output line from the battery pack and effectively disables the battery.

The battery itself may include a display unit, and the history or stored contents of the battery stored in the memory may be displayed on the display unit. A display by this display unit may indicate that the battery is “normal”, “failed”, “self-protected (interlocked)”, etc. by lighting, blinking, color coding, etc. depending on display elements. Embodiments of the display elements include LEDs, organic EL elements, liquid crystal display elements, and the like.

In all cases, regardless of whether the battery is equipped on a drone or charger, the memory may be provided to store data regarding battery history and battery status. When the data stored in the memory is the data unsuitable for use by a particular battery, the output from the battery pack is cut off to disable the battery.

### REFERENCE SIGNS LIST

1 battery

2 drone (unmanned aerial vehicle)

3 charger

11 battery pack

12 impact sensor

13 submersion sensor

14 memory

15 switch controller

16 switch

18 charging record unit

21 motor

22 motor unit

23 impact sensor (on the unmanned aerial vehicle side)

24 submersion sensor (on the unmanned aerial vehicle side)

28 memory (on the unmanned aerial vehicle side)

1. (canceled).

2. An unmanned aerial vehicle, capable of carrying a detachable battery, comprising: a battery pack having a battery cell, a sensor detecting a phenomenon causing a failure in a function of the battery pack, a memory storing a detection signal of the sensor, and a cutoff circuit cutting off a power supply line an output from the battery pack by the detection signal,
wherein the sensor is an aerial vehicle side sensor equipped outside of the battery and on an unmanned aerial vehicle side;
wherein the memory is equipped in the battery and stores the detection signal of the aerial vehicle side sensor received through a connector connecting the battery and the unmanned aerial vehicle; and
wherein the cutoff circuit is equipped on the unmanned aerial vehicle side and cuts off the power supply line output from the battery pack by inputting the a detection signal of the aerial vehicle side sensor stored in the memory to a switch controller controlling the cutoff circuit.

3. The unmanned aerial vehicle according to claim 2, wherein the aerial vehicle side sensor is a sensor detecting an impact.

4. The unmanned aerial vehicle according to claim 2, wherein the aerial vehicle side sensor is a sensor detecting a submersion.

5. (canceled).

6. The unmanned aerial vehicle according to claim 2, wherein the aerial vehicle side sensor is an impact detection sensor having at least one of an acceleration sensor and an angular velocity sensor.

7. The unmanned aerial vehicle according to claim 2, wherein the aerial vehicle side sensor is a contact detection sensor operated by an impact force applied to an airframe protection member.

8. The unmanned aerial vehicle according to claim 2 further comprising an aerial vehicle side memory different from the memory and capable of storing the detection signal of the aerial vehicle side and an ID that identifies the battery for each individuals;
wherein the aerial vehicle side memory operates the cutoff circuit when the battery identified by the ID has a history of cutting off an output from the battery pack.

9.-10. (canceled).

11. The unmanned aerial vehicle according to claim 2 comprising a monitoring function of the battery to prohibit charging of the battery when the monitoring function determines that the battery is inappropriate for use.

12. (canceled).

13. A moving body, capable of carrying a detachable battery, comprising:
a battery pack having a battery cell;
a sensor detecting a phenomenon causing a failure in a function of the battery pack;
a memory storing a detection signal of the sensor; and
a cutoff circuit cutting off a power supply line an output from the battery pack by the detection signal;
wherein the sensor is a moving body side sensor equipped outside of the battery and on a moving body side;
wherein the memory is equipped in the battery and stores the detection signal of the moving body side sensor received through a connector connecting the battery and the moving body; and
wherein the cutoff circuit is equipped on the moving body side and cuts off the power supply line from the battery pack by inputting the detection signal of the moving body side sensor stored in the memory to a switch controller controlling the cutoff circuit.

14. (canceled).
